(19) United States
(12) Patent Application Publication
(10) Pub. No.: US 2017/0202352 A1
(43) Pub. Date: Jul. 20, 2017

(54) Storage Method

(71) Applicant: Laurent Dupont, Winnipeg (CA)

(72) Inventor: Laurent Dupont, Winnipeg (CA)

(21) Appl. No.: 15/406,110

(22) Filed: Jan. 13, 2017

Related U.S. Application Data
(60) Provisional application No. 62/280,313, filed on Jan. 19, 2016.

(51) Int. Cl. A47B 81/00; F16B 2/26

(52) U.S. Cl. CPC A47B 81/005; F16B 2/26

(57) ABSTRACT

Items are stored on a support by taking an elongate cord with a first loop formed at a first end and a second loop formed at a second end, at the first end of the cord wrapping the cord around an elongate handle of an item to be stored, arranging the first end of the cord when wrapped to pass through the first loop so as to attach the first end to the member and hanging the second end of the cord from a support in a storage area so that the elongate handle is held by friction of the cord on the handle.

This application claims the benefit under 35 USC 119 (e) of Provisional Application 62/ filed Jan. 19, 2016.

This invention relates to a method of storage of items having an elongate handle portion or otherwise.

### BACKGROUND OF THE INVENTION

Storage of various items in a storage room or garage area is typically difficult where it is required to suspend the items from a wall or structure adjacent a wall so as to lift the items from the floor. Many brackets and similar devices which can be attached to the wall are available for engaging a portion of the item to be hung over the bracket. In some simple cases, simply a nail or screw is attached to the wall as a hanger. An item such as an axe or shovel can be attached by placing the handle between two projecting members so that the T-bar at the end of the handle is carried on those members. However more difficulty is encountered where the handle such as for a broom or rake is simply an elongated rod with no cross bar at the end.

### SUMMARY OF THE INVENTION

It is an object of the present invention to provide a method for storage of items particularly where the item includes a handle defined by a simple elongate rod.

According to the invention there is provided a method for storing items on a support comprising:

taking an elongate cord with a first loop formed at a first end and a second loop formed at a second end;

at the first end of the cord wrapping the cord around a member of an item to be stored;

arranging the first end of the cord when wrapped to pass through the first loop so as to attach the first end to the member;

and hanging the second end of the cord from a support in a storage area.

In some cases the member comprises an elongate handle of the item. However the first end of the cord can also be attached to a suitable projecting portion or handle on the item to be stored.

In the case where the member is an elongate handle, preferably the handle is held by friction of the cord on the handle.

In some cases there is a plurality of cords and a plurality of items arranged in a row. Thus for example a wall of the storage area may carry a plurality of hooks or other projecting elements such as very simply a nail all arranged in a row at suitable spacings so that the items can be hung in the row from the hooks.

For simplicity the cord preferably consists solely of the length of the cord and the loops. In commercial operation, a bag of the cords can be supplied for use by a person in a storage location for hanging each of the items to be stored at a suitable position in the storage location for example along one wall. The use of the cords ensures that the items are held supported away from the ground and maintain their position along the wall and thus away from the usable area on the floor.

In some cases the second end is simply looped over a support such as a hook or nail.

In other cases the second end is wrapped around a support and the second end of the cord when wrapped is arranged to pass through the second loop so as to attach the second end to the support. This arrangement can be used when the support is elongate so that an end of the support is not readily available for the second loop thus requiring that the cord be wrapped around the support.

In this case preferably the support is an elongate member and there is a plurality of cords and a plurality of items arranged in a row along the elongate member. Thus for example the storage method can be used with a pipe or beam in the storage area where the row of cords is arranged with the second ends in a row wrapped around the pipe or beam. This holds the items away from the floor and in a suitable spaced row to prevent entanglement.

In some cases the cord is formed from a polymer in which case the loops are formed by heat sealing an end of the cord to a position part way along the cord.

In other cases the cord is formed from a wire and the loops are formed by a coupling connecting an end of the cord to a position part way along the cord.

In some cases the cord is formed by braiding an end of the cord to a position part way along the cord.

### BRIEF DESCRIPTION OF THE DRAWINGS

One embodiment of the invention will now be described in conjunction with the accompanying drawings in which:

FIG. 1 is a side elevational view of a cord for use in a method according to the present invention.

FIG. 2 is a side elevational view of a first method of use of the cord of FIG. 1 where the first end is wrapped around the handle of the object and the second end of the cord is attached by the loop to a hook.

FIG. 2A shows the forming of a loop for wrapping the first end.

FIG. 3 is a side elevational view of a second method of use of the cord of FIG. 1 wherein the second end of the cord is wrapped around an elongate support.

In the drawings like characters of reference indicate corresponding parts in the different figures.

### DETAILED DESCRIPTION

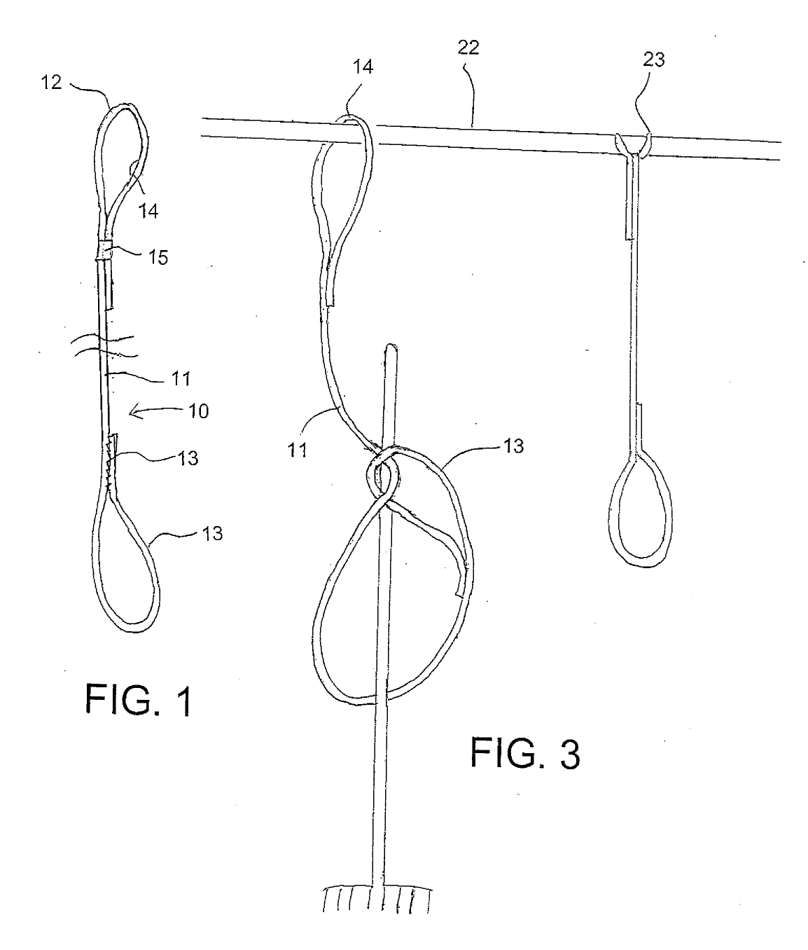

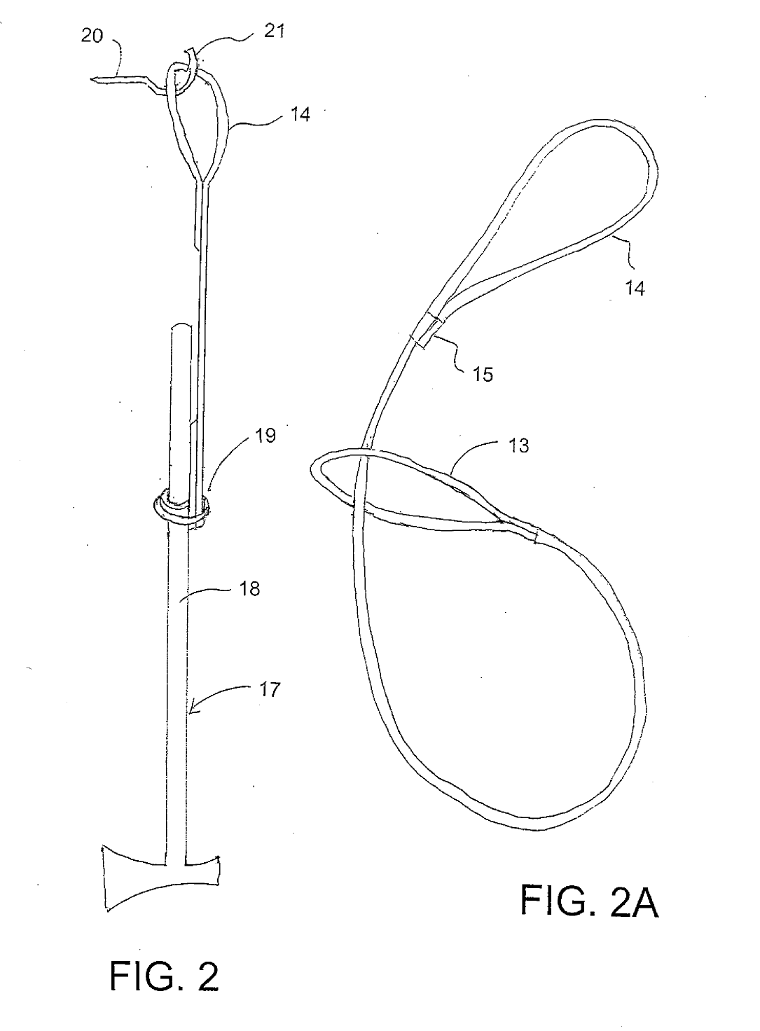

In FIG. 1 is a cord 10 for use in a method of the present invention in which the cord comprises an elongate cord portion 11 and two loops 12 and 13. The left hand end of the cord, the cord is formed from a polymer material which allows the loop to be formed by heat sealing a portion 13 of the end of the cord to the cord itself to form a closed loop 14. FIG. 2A, the cord is shown formed from a metal or wire where the loop 13 is formed by a clamped coupling 15 connecting the end of the cord to the cord itself to form a closed loop 16.

The term cord used herein is not intended to limit the construction of the cord to any particular arrangement so that the material forming the cord can be of any suitable structure. Thus the term cord is intended to include straps, wires.

One particular useful effect of the method according to the present invention is that it can be used to support a member 17 which is in the form simply opening elongate handle without any upper cross-member so that the cord is held in place merely by friction of the cord on the elongate handle. Shown in FIG. 2 the first end of the cord is wrapped around a handle 18 of the member 17 at a position 19 by inserting a portion of the cord through the loop 16 and pulling the loop formed tight against the outside surface of the handle to engage the surface by friction and to support the item 17 accordingly.

Of course the same looping effect can be used with other items even though they may include a transverse bar such as a shovel which typically includes a cross fall at the upper end of the handle. In yet further cases the loop 16 can be engaged over a projecting portion of an item without the necessity to wrap the cord around the projecting portion. Thus the arrangement has wide effect for different arrangements of items to be supported.

In FIG. 2 the second loop 14 is simply engaged over a hook 20 without necessity for wrapping the cord around the hook 20 since an outer end 21 of the hook is readily available.

In FIG. 3 the support for the item 17 is in the form of an elongate member 22 so that it is necessary to wrap the end of the cord around the support 22 at a position 23 on the support following which the other end of the cord is wrapped around the object 17. This allows for the cords 10 to be positioned at spaced locations along the support.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for storing items on a support comprising:
taking an elongate cord with a first loop formed at a first end and a second loop formed at a second end;
at the first end of the cord wrapping the cord around a member of an item to be stored;
arranging the first end of the cord when wrapped to pass through the first loop so as to attach the first end to the member;
and hanging the second end of the cord from a support in a storage area.

2. The method according to claim 1 wherein the member comprises an elongate handle of the item.

3. The method according to claim 2 wherein the elongate handle is held by friction of the cord on the handle.

4. The method according to claim 1 wherein there is a plurality of cords and a plurality of items arranged in a row.

5. The method according to claim 1 wherein the cord consists of the length of the cord and the loops.

6. The method according to claim 1 wherein the second end is looped over a support.

7. The method according to claim 1 wherein the second end is wrapped around a support and the second end of the cord when wrapped is arranged to pass through the second loop so as to attach the second end to the support.

8. The method according to claim 7 wherein the support is an elongate member and there is a plurality of cords and a plurality of items arranged in a row along the elongate member.

9. The method according to claim 1 wherein the cord is formed from a polymer and wherein the loops are formed by heat sealing an end of the cord to a position part way along the cord.

10. The method according to claim 1 wherein the cord is formed from a wire and the loops are formed by a coupling connecting an end of the cord to a position part way along the cord.
